(19) United States
(12) Patent Application Publication
(10) Pub. No.: US 2022/0050314 A1
(43) Pub. Date: Feb. 17, 2022

(54) SELECTIVE PRIVACY DISPLAYS

(71) Applicant: HEWLETT-PACKARD DEVELOPMENT COMPANY, L.P., Spring, TX (US)

(72) Inventors: Hsing-Hung Hsieh, Taipei City (TW); Wan Ching Lee, Taipei City (TW); Dehuei Chen, Taipei City (TW)

(73) Assignee: HEWLETT-PACKARD DEVELOPMENT COMPANY, L.P., Spring, TX (US)

(21) Appl. No.: 17/413,756

(22) PCT Filed: Dec. 13, 2018
(86) PCT No.: PCT/US2018/065429

§ 371 Date: Jun. 14, 2021

(51) Int. Cl. G02F 1/13; G02F 1/1334; G02F 1/1368; G02F 1/1335; F21V 8/00; G02F 1/1343; G02F 1/137; G09G 3/34; G09G 3/36

(52) U.S. Cl. CPC G02F 1/1323; G02F 1/1334; G02F 1/1368; G02F 1/133514; G02B 6/005; G02F 1/134309; G06F 3/0488; G09G 3/342; G09G 3/3648; G02F 2203/03; G09G 2354/00; G09G 2358/00; G09G 2300/0478; G02F 1/13756

(57) ABSTRACT

In example implementations, a display is provided. The display includes a collimated back light unit (BLU) comprising a light guide plate and a plurality of light emitting diodes (LEDs), a polymer dispersed liquid crystal (PDLC) layer formed over the collimated BLU, a thin film transistor (TFT) substrate, a liquid crystal layer formed over the TFT substrate, a color filter (CF) substrate, and a controller. The PDLC layer is to provide selective privacy areas on the display. The TFT substrate is to control emission of light from the plurality of LEDs. The CF substrate is to control a color of the light emitted from the plurality of LEDs. The controller is communicatively coupled to the plurality of LEDs and the POLO layer to activate a selected area of the PDLC layer to enable a privacy area on a corresponding area that is selected on the display.

### BACKGROUND

Displays can be used to produce a visible image. Displays have evolved over time from cathode ray tube (CRT) based displays to liquid crystal displays (LCD) which are integrated with light emitting diodes (LEDs) as light sources. The LCD based displays can provide a smaller and lighter display that is more energy efficient than CRT based displays.

LCD based display can have a wide viewing angle as light is distributed at wide angles from the LCDs. Emitting light at wide viewing angles may allow a user to see the display at a variety of viewing positions rather than having to sit directly in front of the display. However, wide viewing angles may also allow neighbors sitting next to a user to view the display.

### BRIEF DESCRIPTION OF THE DRAWINGS

FIG. 1 is a block diagram of an example cross-sectional view of a display of the present disclosure;

FIG. 2 is a block diagram of an example display with a black privacy screen of the present disclosure;

FIG. 3 is a block diagram of an example selective privacy area on the display of the present disclosure;

FIG. 4 is a flow chart of an example method for activating a select privacy area on a display the present disclosure; and

FIG. 5 is a block diagram of an example non-transitory computer readable storage medium storing instructions executed by a processor to activate a select privacy area on a display.

### DETAILED DESCRIPTION

Examples described herein provide displays with selective privacy displays. As discussed above, some LCD based displays may have wide viewing angles. As a result, if a user is looking at sensitive information on the display, neighbors sitting next to the user may also view the display and see the sensitive information.

Some LCD based displays provide a privacy mode. However, the privacy mode may use scatter light at high levels of brightness from the LCDs that creates a very bright or white mode privacy screen. This type of privacy mode may disturb neighbors (e.g., on an airplane). In addition, extreme scattering can cause flickering on the screen that may also be distracting to neighbors sitting next to the user.

Examples herein provide a display that provides a privacy function with a black screen. Thus, the screen is minimally distracting to neighbors sitting next to a user.

In addition, the display may provide selective privacy areas. For example, the user may select areas of the display to enable the privacy function, while working normally in different portions of the display.

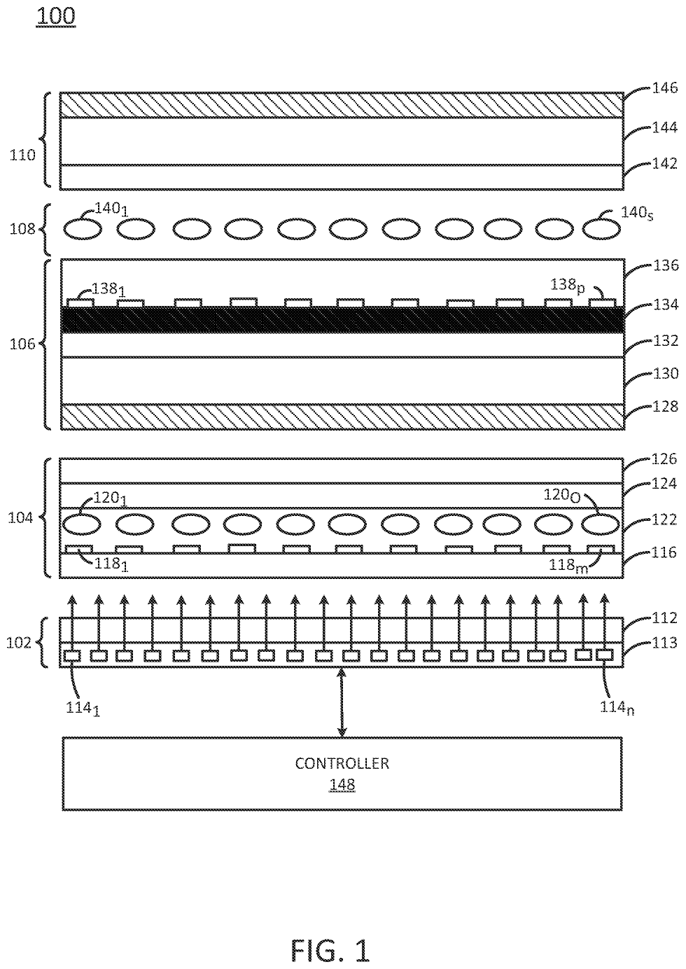

FIG. 1 illustrates an example cross-sectional view of a display 100 with a black selective privacy screen of the present disclosure. The display 100 may be a television, a computer monitor, and the like. The display 100 may be used to generate an image or motion video. The display 100 may provide color images using any color display technology (e.g., a red, green, blue (RGB) display).

In an example, the display 100 may include a collimated backlight unit (BLU) 102 with a plurality of light emitting diodes (LEDs) 114₁ to 114ₙ (hereinafter also referred to individually as an LED 114 or collectively as LEDs 114). The LEDs 114 may provide light to display an image on the display 100. The LEDs 114 may emit enough light or luminance to illuminate the display 100. The size or brightness of the LEDs 114 may be a function of a size of the display 100. For example, a large display may use brighter LEDs 114. A smaller display may use either fewer LEDs 114 or dimmer LEDs 114.

In one example, the LEDs 114 may be located along an edge of a light guide plate 113. The LEDs 114 may inject light into the light guide plate 113. The light guide plate 113 may then direct light as shown by the arrows in FIG. 1 towards a collimator 112. Although the LEDs 114 appear to be inside of the light guide plate 113 in the cross-sectional view of FIG. 1, it should be noted that the LEDs 114 may be located along an edge of the light guide plate 113.

In one example, the collimated BLU 102 may also include the collimator 112. The collimator 112 may be a lens, a prism sheet, or a parabolic reflector that collimates the light emitted from the LEDs 114 into a narrow beam of light. Although FIG. 1 illustrates the collimator 112 as being located above the light guide plate 113, it should be noted that the collimator 112 may be located below the light guide plate 113. For example, when the collimator 112 is a lens or a prism sheet, the collimator 114 may be located above the light guide plate 113. In one example, when the collimator 112 is a reflector, the light guide plate 113 may be located above the collimator 112.

Collimation may redirect light emitted from the light guide plate 113 to within a desired range based on the design of the collimator 112. For example, the light emitted from the LEDs 114 or light guide plate 113 may be emitted in a semi-spherical pattern that may span approximately 180 degrees from side to side. However, the collimator 112 may collimate the light into a narrow beam of light (e.g., within +/−10-30 degrees from a central light emitting axis of the light guide plate 113 or a light ray that is normal to the light guide plate 113 that represents 0 degrees). For example, the arrows from the light guide plate 113 illustrated in FIG. 1 may be the central light emitting axis. The collimator 112 may collimate the light beam to be within a narrow viewing angle relative to the central light emitting axis.

The display 100 may include a polymer dispersed liquid crystal (PDLC) layer 104 located above the collimated BLU 102. The PDLC layer 104 may include a glass substrate 116, a layer 122 that includes a plurality of pixel electrodes 118₁-118ₘ (hereinafter also referred to individually as a pixel electrode 118 or collectively as pixel electrodes 118) and a plurality of PDLCs 120₁-120ₒ (hereinafter also referred to individually as a PDLC 120 or collectively as PDLCs 120), a common electrode 124, and a glass substrate 126. The PDLC layer 104 may also include thin film transistor (TFT) devices (not shown) on the glass substrate 116 to selectively control the voltages of pixel electrodes 118.

In one example, the PDLCs 120 may be dispersed in a polymer such as silicone, polyvinylchloride, polycarbonate, and the like. The polymer may be an optically clear polymer. The polymer may hold the PDLCs 120 in place or fix a position of the PDLCs 120, while allowing the PDLCs 120 to rotate, turn, spin, or change orientation when exposed to a voltage.

In one example, each PDLC 120 may be aligned with a pixel electrode 118. Thus, the display 100 may include a grid of PLDCs 120 and pixel electrodes 118. As discussed in further details below, when a user selects a portion of the display 100 to activate a selective privacy mode, the pixel electrodes 118 that are associated with the PDLCs 120 within a user selected area may be activated. The pixel electrodes 118 may apply a voltage to the PDLCs 120 within the user selected area to orient the PDLCs 120 to allow the collimated light from the collimated BLU 102 to pass through. As a result, the user selected area may appear black when viewed at wide angles outside of the range of collimation.

In other words, using the example above, the light emitted from the light guide plate 113 may be collimated to within an angle of 30 degrees relative to the central light emitting axis of the light guide plate 113. Any person who attempts to view the selected area at a viewing angle greater than 30 degrees may not see the content within the user selected area that has the privacy mode enabled.

However, the remaining PDLCs 120 that do not receive a voltage from the respective pixel electrodes 118 may be oriented to scatter the light from the collimated BLU 102. As a result, the remaining portion of the display 100 may be seen at wider angles. Thus, the pixel electrodes 118 may allow the privacy mode to be enabled for selective portions of the display 100 rather than the entire display 100.

In one example, the PDLC layer 104 may also include a common electrode 124. When, the privacy mode for the entire display is enabled, the common electrode 124 may be activated. The common electrode 124 may apply a voltage to all of the PDLCs 120. As a result, all of the PDLCs 120 may be oriented to allow the light from the collimated BLU 102 to pass through. Thus, the display may be viewed at a viewing angle within the range of collimation of light emitted from the collimated BLU 102.

When viewed from angles that are outside of the range of collimation, the content shown on the display 100 may not be visible. In addition, the display 100 may appear black. As a result, when the display 100 has the privacy mode enabled, the display 100 may not emit bright light that may disturb individuals sitting next to a user of the display 100. For example, a user may use the display 100 on a plane at night without disturbing nearby passengers.

The display 100 may include a thin film transistor (TFT) substrate 106 formed over the PDLC layer 104. The TFT substrate 106 may control emission of light from the LEDs 114. The TFT substrate 106 may include a glass substrate 130. A polarizer 128 may be located on a bottom side of the glass substrate 130 and a common electrode 132 may be located on a top side of the glass substrate 130. The TFT substrate 106 may include an insulator 134 on the common electrode 132 and an alignment layer 136 having a plurality of pixel electrodes 138₁ to 138ₚ (hereinafter also referred to individually as a pixel electrode 138 or collectively as pixel electrodes 138). The TFT substrate 106 may also include TFT devices (not shown) on a top side of the glass substrate 130 and under the common electrode 132.

The display 100 may include a liquid crystal layer 108 over the TFT substrate 106. The liquid crystal layer 108 may be located between the TFT substrate 106 and a color filter (CF) substrate 110.

The liquid crystal layer 108 may include a plurality of liquid crystals 140₁ to 140ₛ (hereinafter also referred to individually as a liquid crystal 140 or collectively as liquid crystals 140). The orientation of the liquid crystals 140 may determine whether light emitted from the LEDs 114 passes through to a particular pixel of the display 100. In one example, the orientation of the liquid crystals 140 can be controlled by applying a voltage to a respective pixel electrode 138.

In one example, the alignment layer 136 may be a rubbed polyimide layer on the pixel electrodes 138. The pixel electrodes 138 may control respective liquid crystals 140 and remain aligned with the respective liquid crystals 140.

The CF substrate 110 may include a glass substrate 144 with color filters, and a polarizer 146 may be located on a top side of the glass substrate 144. The color filters in the glass substrate 144 may be red, green, and blue color filters that help to convert a light emitted by the LEDs 114 into a desired color that is shown on the display 100. An alignment layer 142 may be located on a bottom side of the glass substrate 144. The alignment layer 142 may be a rubbed polyimide layer formed on a bottom side of the glass substrate 144.

In one example, the display 100 may include a controller 148. The controller 148 may be a processor or an application specific integrated circuit (ASIC) to perform a particular function. The controller 148 may be communicatively coupled to the LEDs 114 and control operation of the LEDs. 114 and the PLDC layer 104. For example, the controller 148 may control which LEDs 114 turn on, a brightness level of each LED 114, and the like.

The controller 148 may also receive an indication to enable a privacy mode (e.g., a user input in a computing system of the display 100, an activation button on the computing system, and the like). In one example, the privacy mode may be for a full screen privacy mode. Thus, the controller 148 may activate the common electrode 124 of the PDLC layer 104.

In another example, the privacy mode may be a partial display privacy mode. For example, the controller 148 may receive an indication of an area on the display 100 that is selected to enable the privacy mode. The selection may be made via a touch input for touch screens, via a cursor controlled by an input device (e.g., a mouse or a trackpad), or any other input means.

In one example, the selected area may be a predetermined subsection of the display 100. For example, the PDLCs 120 may be divided into predetermined areas (e.g., quadrants, a grid of symmetric blocks, two halves, and the like). Thus, when the user selects an area of the display, the predetermined area or areas that encompass the selected area may have the partial display privacy mode enabled.

In one example, the selected area may be dynamic. For example, the user may draw an area on the display 100 to enable the partial display privacy mode. For example, the user may draw a box, a circle, a freeform shape, and the like, around text, an image, or any other image on the display 100 to enable the partial display privacy mode.

The controller 148 may determine which PDLCs 120 are associated with, or located within, the area of the display 100 that is selected. The controller 148 may then activate the pixel electrodes 118 that are associated with the PDLCs 120 within the area of the display 100. Activation of the pixel electrodes 118 may cause the PDLCs 120 within the selected area of the display 100 to be oriented to enable the privacy mode within the selected area of the display 100.

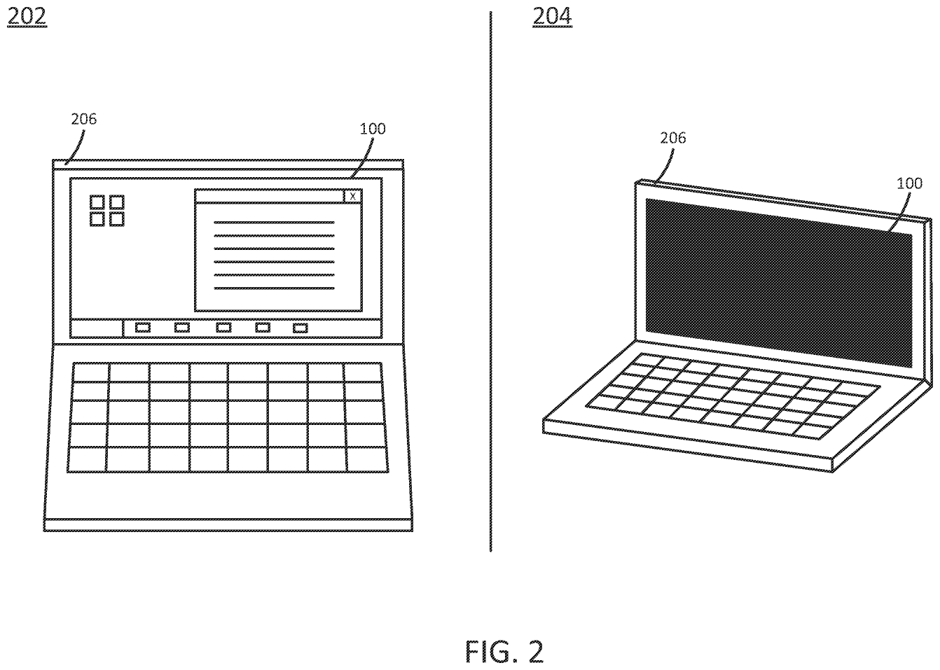

FIG. 2 illustrates an example of the display 100 with a black privacy screen of the present disclosure. FIG. 2 illustrates a view 202 and a view 204. The view 202 may be a viewing angle that is looking straight on the display 100. For example, the view 202 may be the viewpoint of a user sitting directly in front of the display 100.

In one example, the display 100 may be part of a mobile device 206, such as a laptop computer. In one example, the view 202 illustrates how when a full screen privacy mode is enabled, a user may still see images on the display 100. In one example, the privacy mode may be enabled via a selection in a graphical user interface of the mobile device 206 or via a physical button on the mobile device 206.

As discussed above, when the full screen privacy mode is enabled, the controller 148 may activate the common electrode 124 in the PDLC layer 104. The common electrode 124 may apply a voltage to all of the PDLCs 120 that orients the PDLCs 120 to allow the light from the collimated BLU 102 to pass through in a collimated form.

The view 204 illustrates an example of the view of the display 100 at a viewing angle that is greater than the angle of collimation. For example, if the light emitted by the LEDs 114 and the light guide plate 113 is collimated to within +/−30 degrees of the central light emitting axis of the light guide plate 113, then the view 204 may be from a viewing angle that is greater than 30 degrees. As can be seen in the view 204, the display 100 shows a black privacy screen. In other words, the images that were visible in the view 202 are not visible in the view 204.

In addition, the black privacy screen may be less intrusive to persons sitting next to a user of the mobile device 206. The black privacy screen may not scatter light at wider angles. As a result, the black privacy screen may be less distracting for persons sitting next to the user of the mobile device 206.

Furthermore, since the privacy mode is enabled by the collimation of the light emitted by the LEDs 114 and the light guide plate 113, the display 100 may use lower brightness levels of the LEDs 114. As a result, the privacy mode of the present disclosure may use less power, which may allow for longer battery life on the mobile device 206.

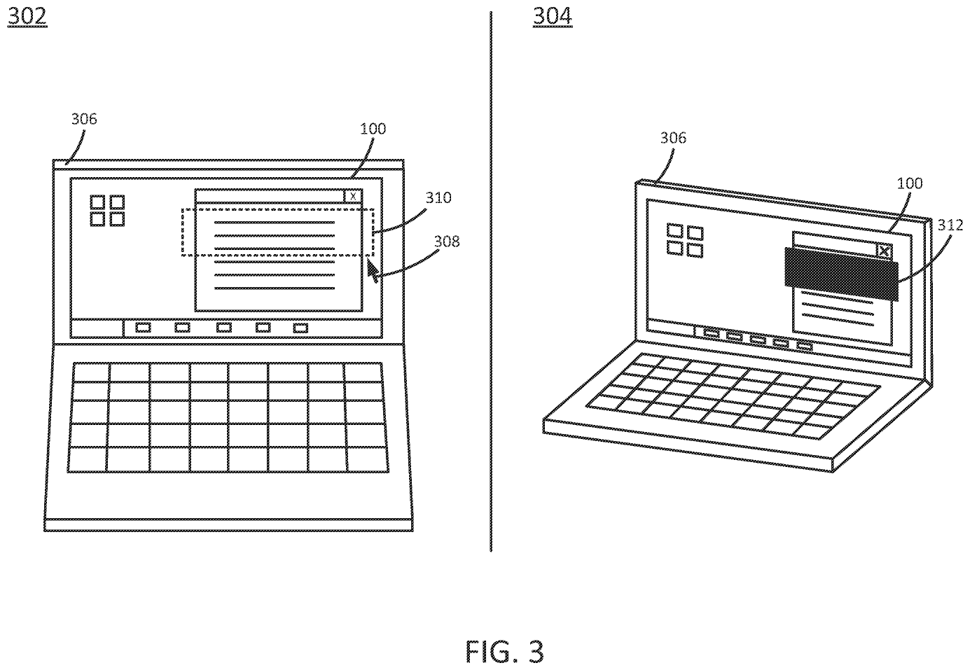

FIG. 3 illustrates an example of the display 100 with a selective privacy area on the display of the present disclosure. FIG. 3 illustrates a view 302 and a view 304. The view 302 may be a viewing angle that is looking straight on the display 100. For example, the view 302 may be the viewpoint of a user sitting directly in front the display 100.

In one example, the display 100 may be part of a mobile device 306, such as a laptop computer. In one example, the view 302 illustrates how an area 310 of the display 100 may be selected for a selective privacy mode or a partial display privacy mode. The selective privacy mode may be enabled via a selection in a graphical user interface of the mobile device 306 or via a physical button on the mobile device 306.

In one example, the area 310 may be selected by outlining the area 310 with a cursor 308. In another example, the area 310 may be selected with a finger, a stylus, or any other input device, that touches the display 100 if the display 100 is a touch screen.

Although the area 310 is shown as rectangle, it should be noted that the area 310 may be any geometric shape such as a square, a circle, an oval, any numbered side polygon (e.g., a pentagon, a hexagon, and the like), and so forth. In one example, the area 310 may be a free form shape. In other words, the area 310 may be drawn into any odd or uneven shape formed by tracing an area with the cursor 308 or a finger of a user on a touch screen.

When the area 310 is selected, the controller 148 may identify the PDLCs 120 that are associated with the area 310. The controller 148 may then apply a voltage to the PDLCs 120 in the area 310 with the respective pixel electrodes 118. As a result, the PDLCs 120 in the area 310 may be oriented to allow collimated light from the collimated BLU 102 to pass through. Thus, the images within the area 310 may be visible when viewed at a viewing angle that is within the angular range of collimation.

The remaining PDLCs 120 outside of the area 310 may be oriented to scatter light, or de-collimate, the light from the collimated BLU 102. As a result the portions of the display 100 outside of the area 310 may be visible at wider viewing angles.

The view 304 illustrates an example view of the display 100 at a viewing angle that is greater than the angle of collimation. As can be seen in the view 304, the display 100 shows a black privacy screen 312 within the area 310 that was selected. The portions of the display 100 that are outside of the black privacy screen 312 are still visible at the wider viewing angles.

Thus, the display 100 of the present disclosure provides a black privacy screen that uses collimated light that can be less distracting to persons sitting next to a user of the display 100. In addition, using the collimated light may allow the LEDs 114 to operate at lower brightnesses, thereby conserving power and extending the battery life of mobile devices. Lastly, the display 100 may allow for a selective privacy mode where portions of the display 100 may be selected to enable the black privacy screen.

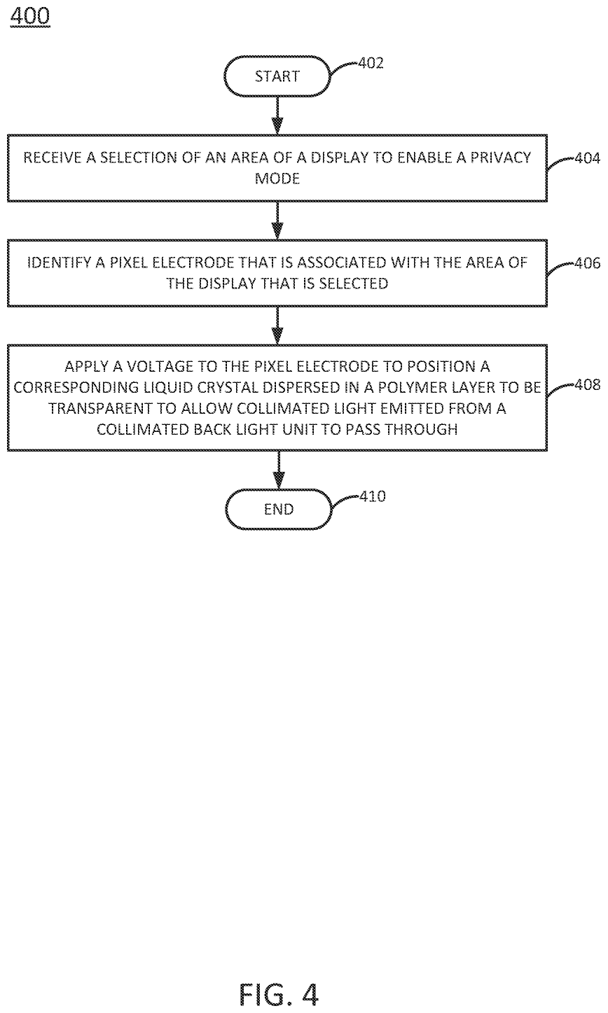

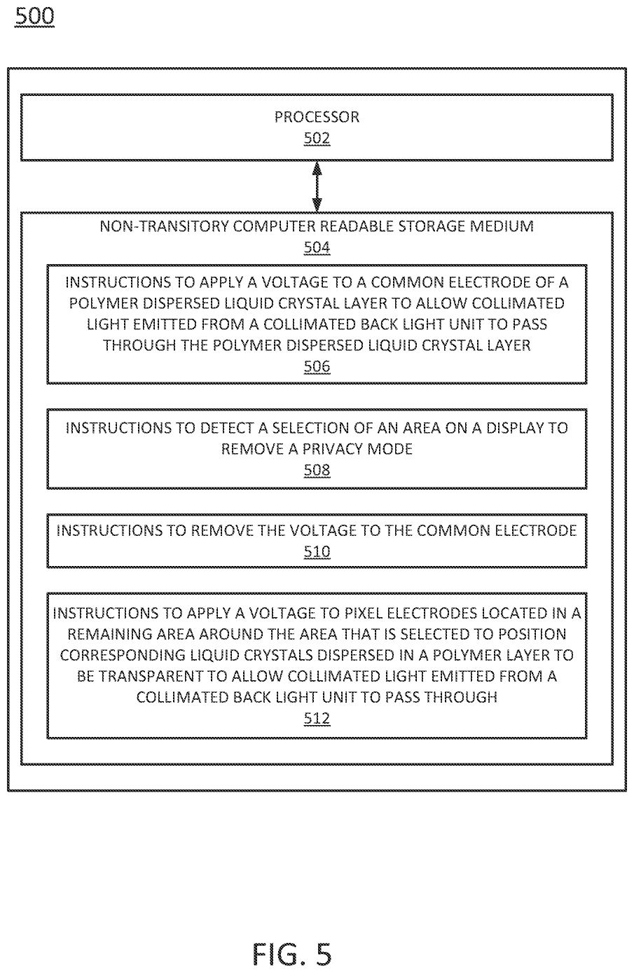

FIG. 4 illustrates a flow diagram of an example method 400 for activating a select privacy area on a display of the present disclosure. In an example, the method 400 may be performed by the display 100, or the apparatus 500 illustrated in FIG. 5, and described below.

At block 402, the method 400 begins. At block 404, the method 400 receives a selection of an area of a display to enable a privacy mode. In one example, the privacy mode may be turned on and off. When the privacy mode is turned on the display may prepare to receive an input for full screen privacy mode or a selective privacy mode.

In one example, for the selective privacy mode a portion of the display may be selected. For example, a user may use his or her finger to select an area on a touch screen display, In another example, a user may select the area by controlling a cursor to draw a selection box around an area with an input device (e.g., a mouse or trackpad).

In one example, the selection area may be a geometric shape. For example, a square, a rectangle, a circle, and the like. In another example, the selection area may be a free form shape. For example, a user may draw any desired shape or line by tracking around the selection area.

At block 406, the method 400 identifies a pixel electrode that is associated with the area of the display that is selected. For example, an area of the display that is selected may be determined from block 404. The pixel electrodes of a polymer dispersed liquid crystal (PDLC) layer that correspond to the area of the display that is selected may be determined. In other words, the pixel electrodes in the PDLC layer that are below the area of the display that is selected may be identified.

At block 408, the method 400 applies a voltage to the pixel electrode to position a corresponding liquid crystal dispersed in a polymer layer to be transparent to allow collimated light emitted from a collimated back light unit to pass through. The voltage may be applied to the pixel electrode or electrodes that are identified to orient the pixel electrodes to allow the collimated light to pass through. Thus, the light emitted from the LEDs and/or light guide plate below the area of the display that is selected may have a narrow viewing angle.

In other words, a user sitting in front of the display may see the portion of the selected display, but others adjacent to the user may not see the portion of the selected display. The portion of the selected display in the selective privacy mode may appear as a black box to adjacent persons.

In one example, the other portions of the display may be visible to persons that are adjacent to the user. For example, the remaining pixel electrodes that do not receive a voltage may be oriented to scatter light. In other words, the collimated light may hit the pixel electrodes that do not receive a voltage and de-collimate the light such that the light may be seen at wider angles.

In one example, the user may decide to enter a full screen privacy mode. As a result, the voltage to the identified pixel electrodes may be removed and a voltage to the common electrodes may be applied. As a result, all of the pixel electrodes in the PDLC layer may be oriented to allow the collimated light emitted from the LEDs to pass through. The entire display may appear black to persons adjacent to the user who may try to look at the display.

When a user disables the privacy mode, the voltage to the PDLCs in the PDLC layer may be removed. The PDLCs may be oriented to scatter the collimated light from the backlight BLU and the images on the display may be seen at wider angles. At block 410, the method 400 ends.

FIG. 5 illustrates an example of an apparatus 500. In an example, the apparatus 500 may be the device 100. In an example, the apparatus 500 may include a processor 502 and a non-transitory computer readable storage medium 504. The non-transitory computer readable storage medium 504 may include instructions 506, 508, 510, and 512 that, when executed by the processor 502, cause the processor 502 to perform various functions.

In an example, the instructions 506 may include instructions to apply a voltage to a common electrode of a polymer dispersed liquid crystal layer to allow collimated light emitted from a collimated back light unit to pass through the polymer dispersed liquid crystal layer. The instructions 508 may include instructions to detect a selection of an area on a display to remove a privacy mode. The instructions 510 may include instructions to remove the voltage to the common electrode. The instructions 512 may include instructions to apply the voltage to pixel electrodes located in a remaining area around the area that is selected to position corresponding liquid crystals dispersed in a polymer layer to be transparent to allow collimated light emitted from a collimated back light unit to pass through.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A display, comprising:
a collimated backlight unit (BLU) comprising a light guide plate and a plurality of light emitting diodes (LEDs);
a polymer dispersed liquid crystal (PDLC) layer formed over the collimated BLU to provide selective privacy areas on the display;
a thin film transistor (TFT) substrate formed over the PDLC layer to control emission of light from the plurality of LEDs and through the PDLC layer;
a liquid crystal layer formed over the TFT substrate;
a color filter (CF) substrate formed over the liquid crystal layer to control a color of the light emitted from the plurality of LEDs; and
a controller communicatively coupled to the plurality of LEDs and the POLO layer to activate a selected area of the POLO layer to enable a privacy area on a corresponding area that is selected on the display.

2. The display of claim 1, wherein the collimated BLU comprises a prism sheet or a reflector to collimate light emitted from the light guide plate to within +/−30 degrees of a central light emitting axis of the light guide plate.

3. The display of claim 1, wherein the PDLC layer comprises:
a first glass substrate;
a plurality of pixel electrodes formed on the glass substrate;
a plurality of liquid crystals dispersed in a polymer layer to fix a position of the plurality of liquid crystals over the plurality of pixel electrodes;
a common electrode formed over the plurality of liquid crystals dispersed in the polymer; and
a second glass substrate formed over the common electrode.

4. The display of claim 3, wherein the plurality of liquid crystals dispersed in the polymer layer are positioned to be transparent when a voltage is applied to the common electrode.

5. The display of claim 3, wherein the plurality of liquid crystals dispersed in the polymer layer are positioned to scatter light emitted from the collimated BLU when no voltage is applied to the common electrode.

6. The display of claim 3, wherein each pixel electrode of the plurality of pixel electrodes is associated with a pixel on the display and is positioned below at least one liquid crystal of the plurality of liquid crystals.

7. The display of claim 6, wherein selection of a pixel on the display causes a voltage to be applied to a pixel electrode that corresponds to the pixel on the display and positions the at least one liquid crystal associated with the pixel electrode to be in a transparent position to allow collimated light from the BLU to pass through the at least one liquid crystal.

8. A method comprising:
receiving, by a processor, a selection of an area of a display to enable a privacy mode;
identifying, by the processor, a pixel electrode that is associated with the area of the display that is selected; and
applying, by the processor, a voltage to the pixel electrode to position a corresponding liquid crystal dispersed in a polymer layer to be transparent to allow collimated light emitted from a collimated back light unit to pass through.

9. The method of claim 8, wherein remaining liquid crystals dispersed in the polymer layer remain in a position to scatter the collimated light.

10. The method of claim 8, wherein the selection is received via a touch screen display.

11. The method of claim 8, wherein the selection is received via an input device controlling a cursor on the display.

12. The method of claim 8, further comprising:
receiving, by the processor, a selection of a full privacy mode;
applying the voltage to a common electrode that causes remaining liquid crystals dispersed in the polymer layer to be positioned to be transparent and allow the collimated light from the collimated back light unit to pass through.

13. A non-transitory computer readable storage medium encoded with instructions executable by a processor, the non-transitory computer-readable storage medium comprising:
instructions to apply a voltage to a common electrode of a polymer dispersed liquid crystal layer to allow collimated light emitted from a collimated back light unit to pass through the polymer dispersed liquid crystal layer, instructions to detect a selection of an area on a display to remove a privacy mode;
instructions to remove the voltage to the common electrode; and
instructions to apply the voltage to pixel electrodes located in a remaining area around the area that is selected to position corresponding liquid crystals dispersed in a polymer layer to be transparent to allow collimated light emitted from a collimated back light unit to pass through.

14. The non-transitory computer readable storage medium of claim 13, wherein the display appears black at viewing angles that are outside a collimation angle of the collimated light.

15. The non-transitory computer readable storage medium of claim 13, wherein pixel electrodes located in the area that is selected do not receive the voltage to cause liquid crystals associated with the pixel electrodes located in the area that is selected to scatter the collimated light.
